(19) United States
(12) Patent Application Publication
(10) Pub. No.: US 2023/0404257 A1
(43) Pub. Date: Dec. 21, 2023

(54) COMBINATION CABINET

(71) Applicant: PRODUCT DEPOT INTERNATIONAL CORP., Taichung City (TW)

(72) Inventor: CHIEN-KUO CHANG, Taichung City (TW)

(21) Appl. No.: 17/842,840

(22) Filed: Jun. 17, 2022

(51) Int. Cl. A47B 49/00; A47B 91/00; B60B 33/00; A47B 47/00

(52) U.S. Cl. CPC A47B 49/002; A47B 91/00; B60B 33/0002; A47B 47/0091

(57) ABSTRACT

A combination cabinet includes a base assembly, a plurality of first containing bodies, and a second containing body. The first containing bodies are removably connected with the base assembly. Each first containing body is disposed in alignment with an edge of the base assembly and does not protrude outward from the edge of the base assembly. The second containing body is pivotally connected with the base assembly and arranged between the first containing bodies. The second containing body is rotatable with respect to the base assembly to protrude outward from the edge of the base assembly. Thus, the present invention is conveniently, efficiently, and easily assembled and providing different storage forms according to different demands.

### BACKGROUND OF THE INVENTION

### 1. Field of the Invention

The present invention relates to cabinets, and more particularly, to a combination cabinet.

### 2. Description of the Related Art

There are a variety of cabinets on the market. For different items, the cabinets are also divided into different size, height or containing space. Therefore, users have to purchase different types of cabinets for storing different types of items.

A conventional cabinet is usually formed in an integral structure. The integrally formed cabinet is sturdy; however, the occupation volume of the cabinet prevents it from being disassembled or having expansions. Therefore, it is inconvenient for the conventional integrally formed cabinet to be transport, and the storage of it consumes relatively large occupation volume.

Although the industry has introduced a type of locker which is assembled according to different demands such as the home space and the size of the to-be-accommodated items, such conventional combination locker is mostly formed of multiple layer plates having the same structure, so as to facilitate the modularization. As a result, the assembled locker only has a single type of storage structure and fails to have changeability.

### SUMMARY OF THE INVENTION

To improve the issues above, the present invention discloses a combination cabinet, which is conveniently, efficiently, and easily assembled and providing different storage forms.

For achieving the aforementioned objectives, the present invention provides a combination cabinet, comprising:
a base assembly;
a plurality of first containing bodies removably connected with the base assembly, each first containing body disposed in alignment with an edge of the base assembly and not protruding outward from the edge of the base assembly; and
a second containing body pivotally connected with the base assembly and arranged between the first containing bodies, the second containing body being rotatable with respect to the base assembly to protrude outward from the edge of the base assembly.

With the combination of a plurality of first containing bodies and the second containing body, the present invention is conveniently, efficiently, and easily assembled and providing different storage forms according to different demands. Therefore, the present invention improves the issue of conventional integral cabinets being difficult to be stored and occupying relatively large volume. Also, the present invention improves the issues of conventional combination locker providing only a single type of storage form.

### BRIEF DESCRIPTION OF THE DRAWINGS

FIG. 1 is a perspective view of the combination cabinet in accordance with an embodiment of the present invention.

FIG. 2 is a perspective view of the combination cabinet taken from another point of view in accordance with an embodiment of the present invention.

FIG. 3 is an exploded view of the combination cabinet in accordance with an embodiment of the present invention.

FIG. 4 is a cross-sectional view taken along line 4-4 of FIG. 1.

FIG. 5 is a cross-sectional view taken along line 5-5 of FIG. 1.

FIG. 6 is a sectional view illustrating the pivot status of the second containing body.

FIG. 7 is a perspective view of the combination cabinet in accordance with the second embodiment of the present invention.

FIG. 8 is a perspective view of the combination cabinet taken from another point of view in accordance with the second embodiment of the present invention.

FIG. 9 is a perspective view of the combination cabinet in accordance with the third embodiment of the present invention.

FIG. 10 is a perspective view of the combination cabinet taken from another point of view in accordance with the third embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

The directional terms of, for example, “above”, “beneath”, “up”, “down”, “front”, “rear”, “left”, “right”, “inner”, “outer”, and “side” are only used herein for illustrating the relative directions shown in the drawings. Therefore, the directional terms are applied for the purpose of illustration and understanding of the present invention, instead of limiting the present invention.

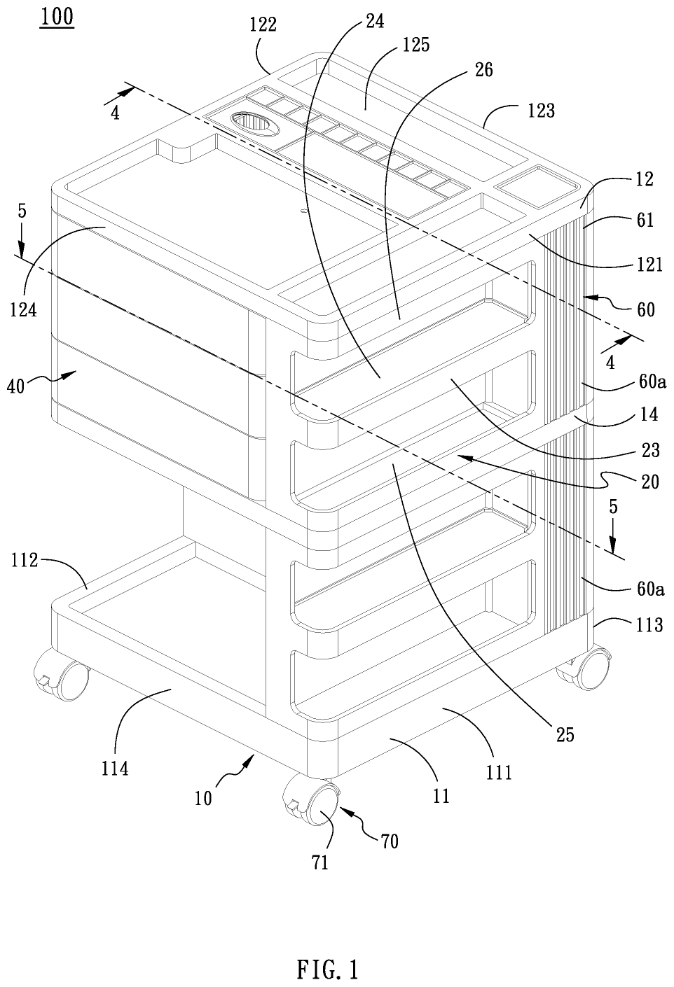

Referring to FIG. 1 to FIG. 10, the present invention provides a combination cabinet 100, comprising a base assembly 10, a plurality of first containing bodies 20, and a second containing body 40.

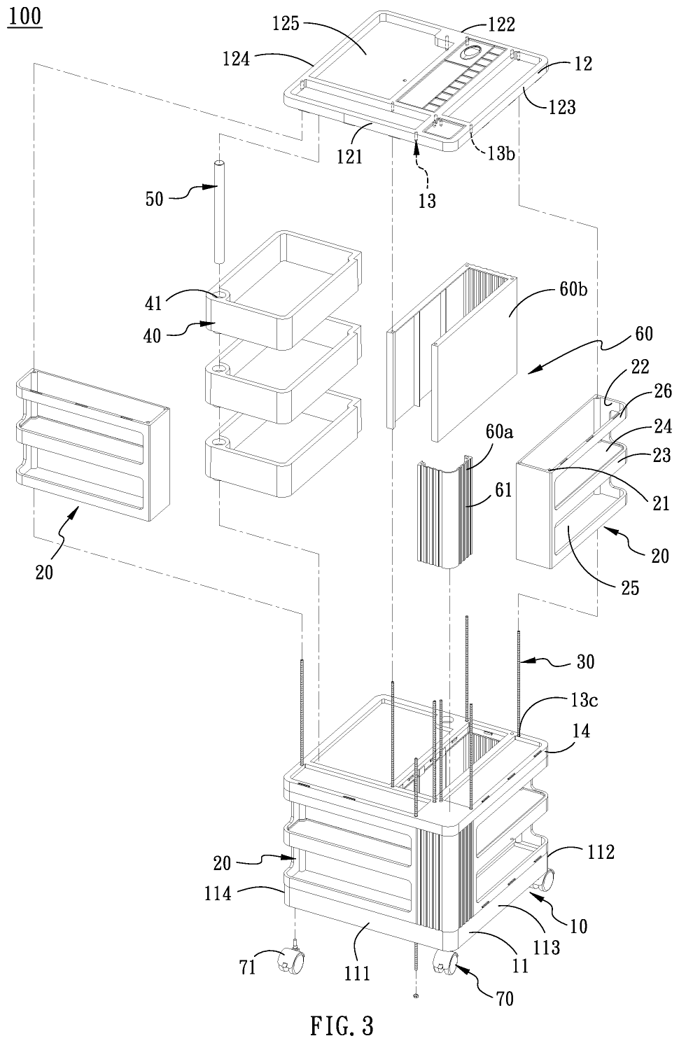

The base assembly 10 comprises a seat 11 and a cover plate 12. The seat 11 and the cover plate 12 are allowed to be formed in a rectangular, circular, or triangular shape, or a combination thereof. In the embodiment, the seat 11 and the cover plate 12 are formed in a rectangular shape. The seat 11 comprises a first lateral side 111, a second lateral side 112, a third lateral side 113, and a fourth lateral side 114. The first lateral side 111 and the second lateral side 112 are perpendicularly connected with the third lateral side 113 and the fourth lateral side 114. The cover plate 12 comprises a fifth lateral side 121, a sixth lateral side 122, a seventh lateral side 123, and an eighth lateral side 124. The fifth lateral side 121 and the sixth lateral side 122 are perpendicularly connected with the seventh lateral side 123 and the eighth lateral side 124. Therein, according to the direction shown by FIG. 1 and FIG. 3, the cover plate 12 is located above the seat 11; the first lateral side 111 is in positional alignment with the fifth lateral side 121; the second lateral side 112 is in positional alignment with the sixth lateral side 122; the third lateral side 113 is in positional alignment with the seventh lateral side 123; and the fourth lateral side 114 is in positional alignment with the eighth lateral side 124.

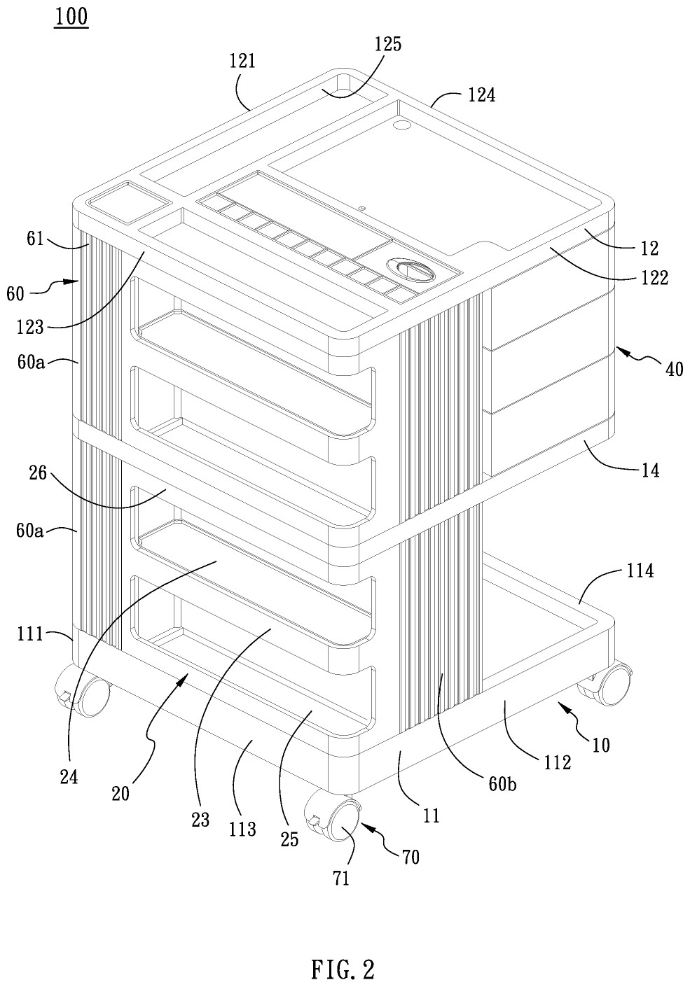

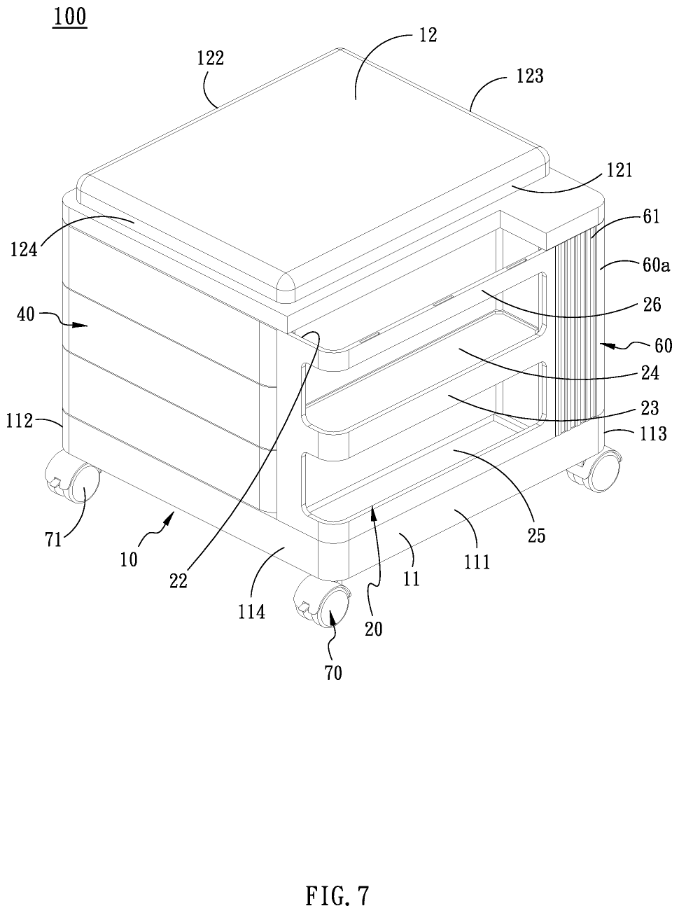

Also, the top face of the cover plate 12 is concavely provided with a plurality of recesses 125 or formed in a plane shape. Referring to FIG. 1 and FIG. 2, in the first embodiment, the cover plate 12 is concavely provided with the recesses 125, and the recesses 125 are allowed to be formed in a rectangular, circular, or triangular shape, or a combination thereof. Also, the sizes of the recesses 125 are different for storing objects with different shapes and sizes. Referring to FIG. 7 to FIG. 10, in the second and third embodiments, the top face of the cover plate 12 is formed in a plane shape.

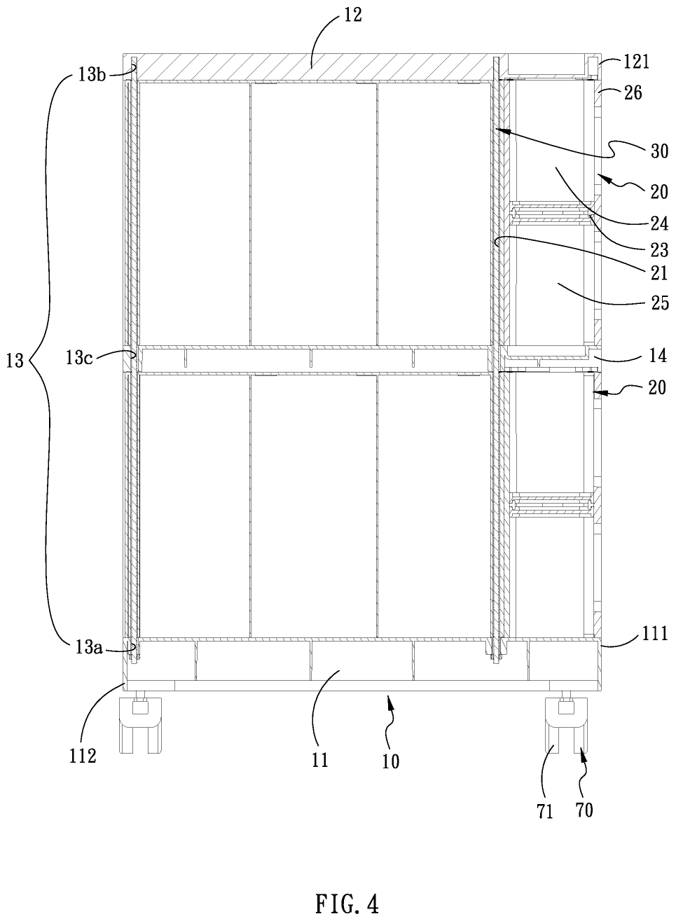

Also, the base assembly 10 comprises a plurality of combination bores 13. The combination bores 13 are divided into a plurality of first combination bores 13a and a plurality of second combination bores 13b. Each first combination bore 13a passes through the seat 11, and each second combination bore 13b is concavely disposed on the bottom face of the cover plate 12, as shown by FIG. 4.

Also, in the first embodiment, the base assembly 10 further comprises a partition 14 disposed between the cover plate 12 and the seat 11. The partition 14 is formed in a shape and a size corresponding to the shape and the size of the seat 11 and the cover plate 12. The partition 14 is allowed to be formed in a rectangular, circular, or triangular shape, or a combination thereof. In the embodiment, the partition 14 is formed in a rectangular shape. Each combination bore 13 further comprises a plurality of third combination bores 13c passing through the partition 14, as shown by FIG. 3 and FIG. 4.

The plurality of first containing bodies 20 are removably connected with the base assembly 10. Therein, each first containing body 20 is disposed in alignment with the edge of the base assembly 10 and does not protrude outward from the edge of the base assembly 10. Each first containing body 20 is disposed between the top face of the seat 11 and the bottom face of the cover plate 12.

Each first containing body 20 is removably connected with the base assembly 10 through a plurality of combination members 30. Therein, each first containing body 20 comprises a plurality of connection bores 21 passing therethrough. Each combination member 30 is able to pass through each connection bore 21 of the first containing body to be engaged with the combination bores 13 of the base assembly 10, as shown by FIG. 3 and FIG. 4. In the embodiments of the present invention, the combination member 30 is a circular thread rod; one end of the combination member 30 is screwed to a nut and engaged on the outside of the first combination bore 13a of the seat 11.

Each first containing body 20 comprises a function bore 22 on the top face thereof. Each first containing body 20 comprises a dividing portion 23, which divides the first containing body 20 into a first housing area 24 and a second housing area 25 which are open. Therein, the function bore 22 is communicated with the first housing area 24. The first containing body 20 comprises a held portion 26 on the outer side thereof corresponding to the function bore 22 and the first housing area 24.

In the first embodiment, four first containing bodies 20 are provided. The four first containing bodies 20 are disposed between the first lateral side 111 of the seat 11 and the partition 14, between the third lateral side 113 of the seat 11 and the partition 14, between the fifth lateral side 121 of the cover plate 12 and the partition 14, and between the seventh lateral side 123 of the cover plate 12 and the partition 14, respectively. Therein, the cover plate 12 covers the function bore 22 on the top face of the two first containing bodies 20, as shown by FIG. 1 to FIG. 3.

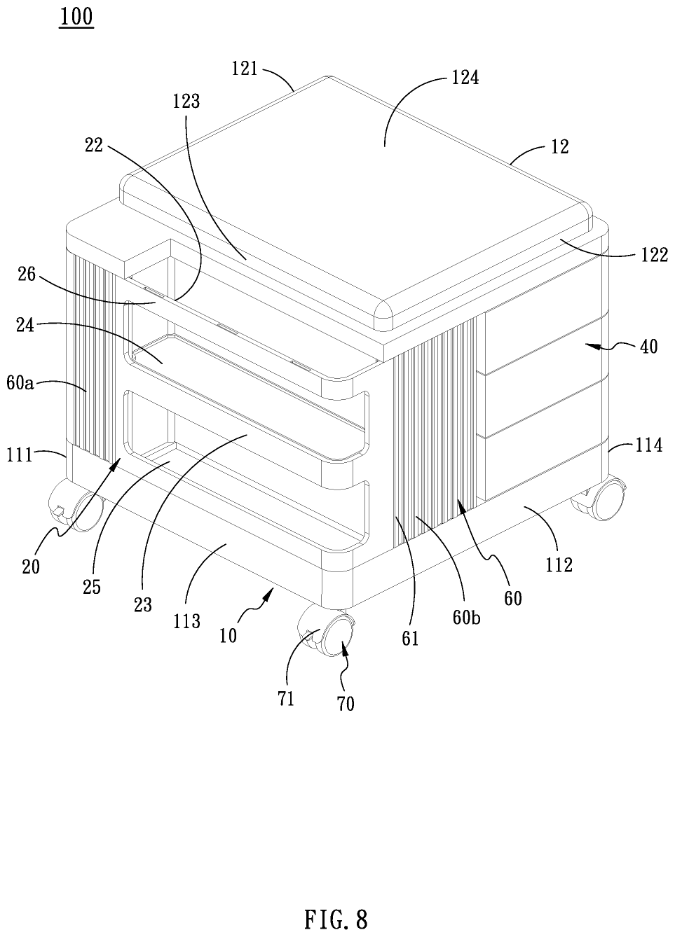

In the second embodiment of the present invention, two first containing bodies 20 are provided. The two first containing bodies 20 are disposed between the first lateral side 111 of the seat 11 and the fifth lateral side 121 of the cover plate 12, and between the third lateral side 113 of the seat 11 and the seventh lateral side 123 of the cover plate 12, respectively. Therein, the cover plate 12 does not cover the function bore 22 of the first containing body 20 between the first lateral side 111 of the seat 11 and the fifth lateral side 121 of the cover plate 12, and also does not cover the function bore 22 of the first containing body 20 between the third lateral side 113 of the seat 11 and the seventh lateral side 123 of the cover plate 12. The held portion 26 of the two first containing bodies 20 are configured to be held by the user, as shown by FIG. 7 and FIG. 8.

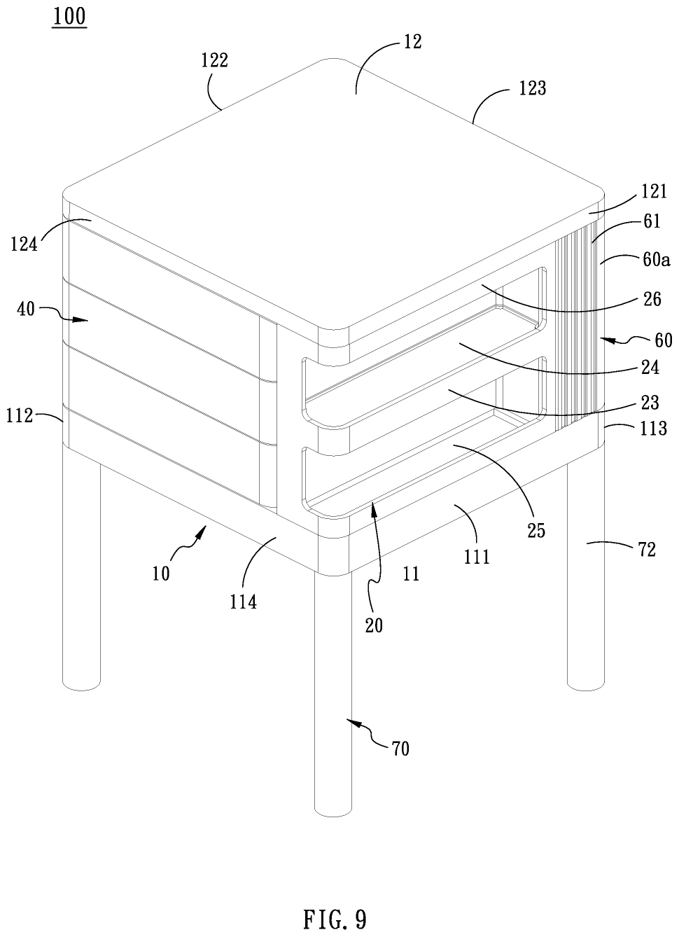

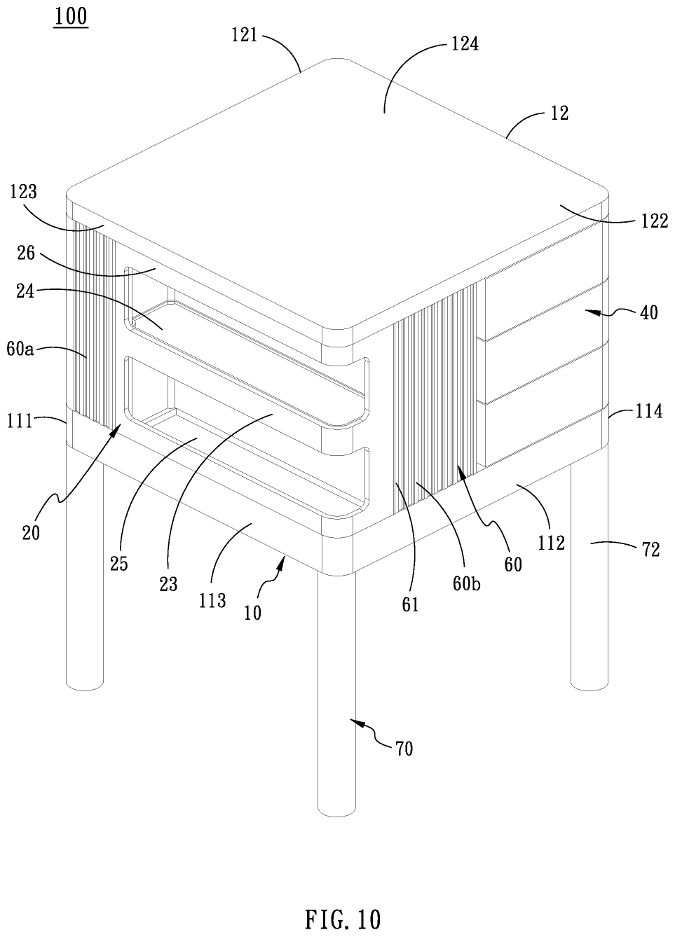

In the third embodiment of the present invention, two first containing bodies 20 are provided. The two first containing bodies 20 are disposed between the first lateral side 111 of the seat 11 and the fifth lateral side 121 of the cover plate 12, and between the third lateral side 113 of the seat 11 and the seventh lateral side 123 of the cover plate 12, respectively. Therein, the cover plate 12 covers the function bore 22 on the top face of the two first containing bodies 20, as shown by FIG. 9 and FIG. 10.

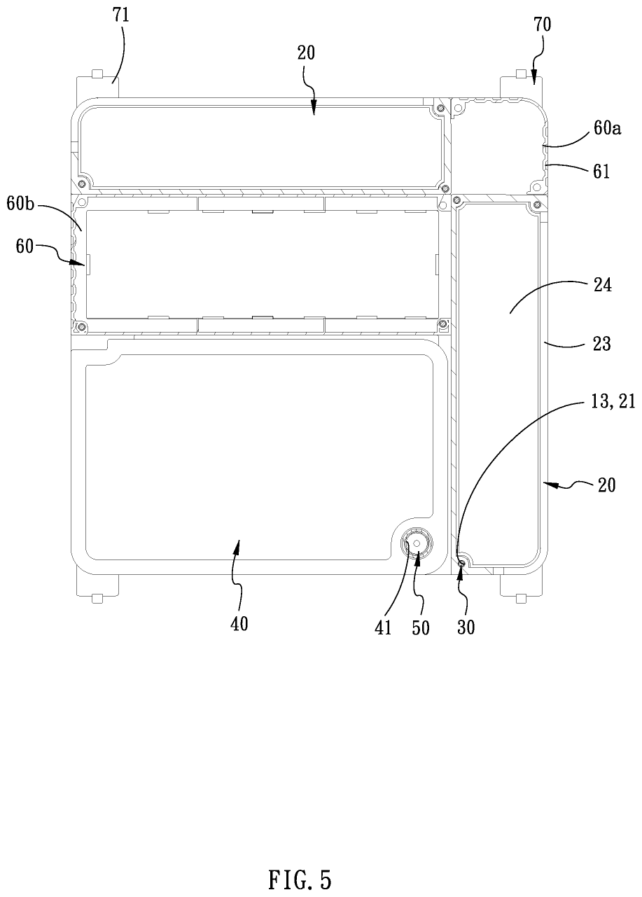

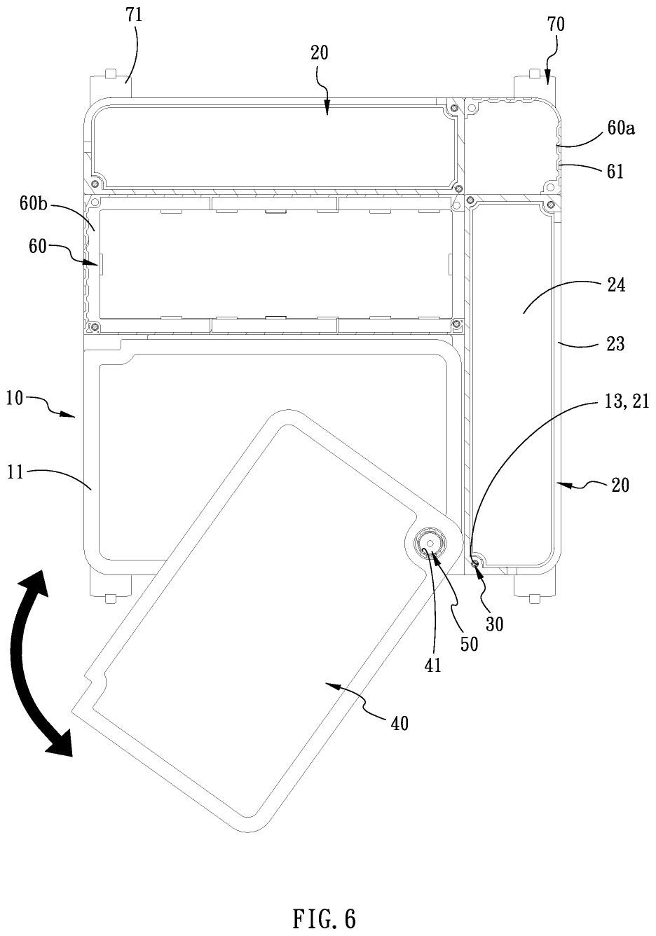

A second containing body 40 is pivotally connected with the base assembly 10 and arranged between the first containing bodies 20. The second containing body 40 is rotatable with respect to the base assembly 10 and protrudes outward from the edge of the base assembly 10. The top face of the second containing body 40 is covered by the cover plate 12. Therein, when the second containing body 40 is folded, the outer periphery of the second containing body 40 does not protrude outward from the base assembly 10, as shown by FIG. 5. When the user needs to place an object in the second containing body 40 or retrieve an object from the second containing body 40, the user is allowed to rotate the second containing body 40 outward with respect to the base assembly 10, so as to open the second containing body 40, as shown by FIG. 6.

In an embodiment, the second containing body 40 is pivotally disposed between the partition 14 and the corner included by the sixth lateral side 122 and the eighth lateral side 124 of the cover plate 12, as shown by FIG. 1, FIG. 2, and FIG. 6. In the second and third embodiments, the second containing body 40 is pivotally disposed between the corner included by the second lateral side 112 and the fourth lateral side 114 of the seat 11 and the corner included by the sixth lateral side 122 and the eighth lateral side 124 of the cover plate 12, as shown by FIG. 7 to FIG. 10.

The second containing body 40 comprises a through hole 41 passing therethrough. A pivot rod 50 passes through the through hole 41 of the second containing body 40 to pivotally connected the second containing body 40 with the base assembly 10. Therein, a plurality of second containing bodies 40 are provided. The plurality of second containing bodies 40 are allowed to be stacked and pivotally connected between the seat 11 and the cover plate 12 of the base assembly 10 or between the cover plate 12 and the partition 14 through the pivot rod 50. In the first embodiment, the second containing bodies 40 are stacked and pivotally disposed between the cover plate 12 of the base assembly 10 and the partition 14, as shown by FIG. 1 and FIG. 2. In the second and third embodiments, the second containing bodies are stacked and pivotally disposed between the seat 11 and the cover plate 12 of the base assembly 10.

A decoration member 60 is disposed between the first containing bodies 20 or between the first containing body 20 and the second containing body 40. Therein, the surface of the decoration member 60 is not completely formed in a plane. In the embodiments, the surface of the decoration member 60 is partially provided with concave grooves 61.

Also, the decoration member 60 is able to comprises a first decoration member 60a and a second decoration member 60b. The first decoration member 60 is disposed between the first containing bodies 20. The second decoration member is disposed between the first containing body 20 and the second containing body 40. In the embodiments, the first decoration member 60a is approximately formed in an L shape, and the second decoration member 60b is approximately formed in a U shape, as shown by FIG. 3.

A foot set 70 is removably disposed on the bottom face of the seat 11. The foot set 70 comprises a plurality of wheels 71 or a plurality of support rods 72. Referring to FIG. 1 and FIG. 6, in the first and second embodiments, the foot set 70 comprises a plurality of wheels 71. Referring to FIG. 8, in the third embodiment, the foot set 70 comprises a plurality of support rods 72.

With the foregoing configuration, technical effects of the present invention will be illustrated below.

With the combination of the first containing bodies 20 and the second containing body 40, the present invention is conveniently, efficiently, and easily assembled and providing different storage forms.

The seat 11 is easily assembled and disassembled with the first containing bodies 20, the second containing body 40, the decoration member 60, and the foot set 70, achieving the convenience of storage and usage.

When the cover plate 12 does not cover the top face of the first containing body 20, the held portion 26 of the first containing body 20 is configured to be held by the user. Also, with the foot set 70 in the form of the wheels 71, the combination cabinet 100 is easily movable, facilitating the convenience of movement.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A combination cabinet, comprising:
a base assembly;
a plurality of first containing bodies removably connected with the base assembly, each first containing body disposed in alignment with an edge of the base assembly and not protruding outward from the edge of the base assembly; and
a second containing body pivotally connected with the base assembly and arranged between the first containing bodies, the second containing body being rotatable with respect to the base assembly to protrude outward from the edge of the base assembly.

2. The combination cabinet of claim 1, wherein the base assembly comprises a seat and a cover plate; each of the first containing bodies are disposed between a top face of the seat and a bottom face of the cover plate; the cover plate is able to cover a top face of the second containing body.

3. The combination cabinet of claim 2, further comprising a foot set removably disposed on a bottom face of the seat; the foot set comprises a plurality of wheels or a plurality of support rods.

4. The combination cabinet of claim 2, wherein a top face of the cover plate concavely comprises a plurality of recesses or is formed in a plane.

5. The combination cabinet of claim 4, further comprising a decoration member disposed between the first containing bodies or between the first containing body and the second containing body.

6. The combination cabinet of claim 1, wherein each first containing body is removably connected with the base assembly through a plurality of combination members; the base assembly comprises a plurality of combination bores; each first containing body comprises a plurality of connection bores; each combination member passes through the corresponding connection bore of each first containing body to be engaged with the corresponding combination bore of the base assembly.

7. The combination cabinet of claim 6, wherein a top face of each first containing body comprises a function bore; each first containing body comprises a dividing portion, which divides the first containing body into a first housing area and a second housing area; the first housing area and the second housing area are open.

8. The combination cabinet of claim 2, wherein the base assembly further comprises a partition disposed between the cover plate and the seat; the second containing body is disposed between the cover plate and the partition.

9. The combination cabinet of claim 1, wherein the second containing body comprises a through hole passing therethrough; a pivot rod passes through the through hole for pivotally connecting the second containing body with the base assembly.

10. The combination cabinet of claim 9, wherein a plurality of the second containing bodies are provided; the plurality of second containing bodies are able to be stacked and pivotally connected with the base assembly through the pivot rod.
